(19) United States
(12) Patent Application Publication
(10) Pub. No.: US 2024/0324505 A1
(43) Pub. Date: Oct. 3, 2024

(54) SYSTEM AND METHOD FOR CLEANING SENSOR ASSEMBLIES OF AN AGRICULTURAL HARVESTER

(71) Applicants: CNH Industrial Belgium N.V., Zedelgem (BE); CNH Industrial Brasil Ltda., Bairro Vale do Sereno (BR)

(72) Inventors: Bart M.A. Missotten, Herent (BE); Yuanyuan Li, Leuven (BE); Andre Satoshi Seki, Bairro Boa Vista (BR); Michael Štelcl, Torhout (BE); Frederik Tallir, Esen (BE); Lucas Deruyter, Gits (BE); Bertl Verschaeve, Gits (BE); Dré W.J. Jongmans, Klundert (NL); João Augusto Marcolin Lucca, Bairro Vila Nova (BR)

(21) Appl. No.: 18/615,625

(22) Filed: Mar. 25, 2024

Related U.S. Application Data
(60) Provisional application No. 63/454,820, filed on Mar. 27, 2023.

(51) Int. Cl. A01D 41/127; A01D 61/00; B08B 1/16

(52) U.S. Cl. CPC A01D 41/1276; B08B 1/165; A01D 61/00

(57) ABSTRACT

A system for cleaning sensor assemblies of an agricultural harvester includes an elevator assembly configured to convey harvested crop material, with the elevator including an elevator frame. Furthermore, the system includes a sensor assembly positioned within the elevator assembly, with the sensor assembly including a weigh plate coupled to the elevator frame such that the weigh plate and the elevator frame define a gap therebetween. The sensor assembly further includes a load sensor coupled between the elevator frame and the weigh plate such that the load sensor is configured to generate data indicative of a weight of the harvested crop material present on the weigh plate. Additionally, the system includes a cleaning device configured to remove debris from the gap.

### FIELD OF THE INVENTION

The present disclosure generally relates to agricultural harvesters and, more particularly, to systems and method for cleaning sensor assemblies of an agricultural harvester.

### BACKGROUND OF THE INVENTION

Agricultural harvesters can include an assembly of processing equipment for processing harvested crop materials. For instance, within a sugarcane harvester, severed sugarcane stalks are conveyed via a feed roller assembly to a chopper assembly that cuts or chops the sugarcane stalks into pieces or billets (e.g., six-inch cane sections). The processed crop material discharged from the chopper assembly is then directed as a stream of billets and debris into a primary extractor, within which the airborne debris (e.g., dust, dirt, leaves, etc.) is separated from the sugar billets. The separated/cleaned billets then fall into an elevator assembly for delivery to an external storage device.

During the operation of the harvester, it may be desirable to monitor the crop yield as the machine goes through the field. In this respect, sensor assemblies for detecting the weight of the billets being conveyed by the elevator assembly have been developed. While such sensor assemblies work well, further improvements are needed. For example, debris may build up around and eventually interfere with the operation of such sensor.

Accordingly, a system and a method for cleaning sensor assemblies of an agricultural harvester would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for cleaning sensor assemblies of an agricultural harvester. The system includes an elevator assembly configured to convey harvested crop material, with the elevator including an elevator frame. Furthermore, the system includes a sensor assembly positioned within the elevator assembly, with the sensor assembly including a weigh plate coupled to the elevator frame such that the weigh plate and the elevator frame define a gap therebetween. The sensor assembly further includes a load sensor coupled between the elevator frame and the weigh plate such that the load sensor is configured to generate data indicative of a weight of the harvested crop material present on the weigh plate. Additionally, the system includes a cleaning device configured to remove debris from the gap.

In another aspect, the present subject matter is directed to an agricultural harvester. The agricultural harvester includes a chassis and an elevator assembly supported on the chassis. The elevator assembly is, in turn, configured to convey harvested crop material, with the elevator including an elevator frame. Moreover, the agricultural harvester includes a sensor assembly positioned within the elevator assembly, with the sensor assembly including a weigh plate coupled to the elevator frame such that the weigh plate and the elevator frame define a gap therebetween. The sensor assembly further includes a load sensor coupled between the elevator frame and the weigh plate such that the load sensor is configured to generate data indicative of a weight of the harvested crop material present on the weigh plate. In addition, the agricultural harvester includes a cleaning device configured to remove debris from the gap.

In a further aspect, the present subject matter is directed to a method for cleaning a sensor assembly of an agricultural harvester. The sensor assembly, in turn, includes a weigh plate coupled to an elevator frame such that a gap is defined between the weigh plate and the elevator frame, with the sensor assembly further including a load sensor coupled between the elevator frame and the weigh plate such that the load sensor is configured to generate data indicative of a weight of harvested crop material present on the weigh plate. The method includes receiving, with a computing system, data generated by the load sensor during operation of the agricultural implement. Furthermore, the method includes receiving, with the computing system, at least one of image data depicting the gap or an input indicating that the agricultural harvester is present in a headland or that an elevator of the elevator assembly will be halted for a predetermined amount of time. Additionally, the method includes initiating, with the computing system, activation of the cleaning device to clean the sensor assembly based on at least one of the received data generated by the load sensor, the received image data depicting the gap, or the received input indicating that the agricultural harvester is present in a headland or that the elevator will be halted for a predetermined amount of time.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a simplified, side view of one embodiment of an agricultural harvester in accordance with aspects of the present subject matter;

FIG. 2 illustrates a bottom view of one embodiment of a sensor assembly of an agricultural harvester in accordance with aspects of the present subject matter, particularly illustrating one embodiment of a cleaning device for the sensor assembly;

FIG. 3 illustrates a top view of the sensor assembly shown in FIG. 2;

FIG. 4 illustrates a partial side view of the sensor assembly shown in FIGS. 2 and 3;

FIG. 5 illustrates a bottom view of another embodiment of a sensor assembly of an agricultural harvester in accordance with aspects of the present subject matter, particularly illustrating another embodiment of a cleaning device for the sensor assembly;

FIG. 6 illustrates a top view of the sensor assembly shown in FIG. 5;

FIG. 7 illustrates another top view of the sensor assembly shown in FIG. 2, particularly illustrating a further embodiment of a cleaning device for the sensor assembly;

FIG. 8 illustrates a side view of the cleaning device shown in FIG. 7, particularly illustrating a scraper blade of the cleaning device at a home position;

FIG. 9 illustrates another side view of the cleaning device shown in FIGS. 7 and 8, particularly illustrating a scraper blade of the cleaning device at an activated position;

FIG. 10 illustrates a side view of the sensor assembly shown in FIG. 5, particularly illustrating yet another embodiment of a cleaning device for the sensor assembly;

FIG. 11 illustrates another side view of the sensor assembly shown in FIG. 5, particularly illustrating yet a further embodiment of a cleaning device for the sensor assembly;

FIG. 12 illustrates another top view of the sensor assembly shown in FIG. 2, particularly illustrating a yet another embodiment of a cleaning device for the sensor assembly;

FIG. 13 illustrates a schematic view of one embodiment of a system for cleaning sensor assemblies of an agricultural harvester in accordance with aspects of the present subject matter; and

FIG. 14 illustrates a flow diagram of one embodiment of a method for cleaning sensor assemblies of an agricultural harvester in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to a system and a method for cleaning sensor assemblies of an agricultural harvester, such as a sugarcane harvester. As will be described below, the agricultural harvester includes an elevator assembly having an elevator frame and an elevator configured to move relative to the elevator frame. In this respect, the elevator includes paddles configured to convey harvested crop material (e.g., sugarcane billets) from a proximal end portion of the elevator assembly to a distal end portion of the elevator assembly. The proximal end portion is, in turn, positioned adjacent to a chopper assembly of the harvester. The harvested crop material is subsequently discharged from the harvester through the distal end portion.

In several embodiments, the disclosed system includes a sensor assembly positioned within the elevator assembly. Specifically, the sensor assembly includes a weigh plate coupled to the elevator frame such that the weigh plate and the elevator frame define one or more gaps therebetween. Furthermore, the sensor assembly includes a load sensor (e.g., a load cell) coupled between the elevator frame and the weigh plate such that the load sensor is configured to generate data indicative of a weight of the harvested crop material present on the weigh plate.

Additionally, the disclosed system includes a cleaning device configured to remove debris from the gap(s). Specifically, in some embodiments, the cleaning device includes a scraper (e.g., having one or scraper blades and/or a scraper bar) configured to be moved through the gap to remove the debris from the gap. For example, the cleaning device may be selectively activated such that the scraper moves through the gap to dislodge any debris present therein when image data indicates that debris is present in the gap, the data being generated by the load sensor indicates that debris may be present in the gap, and/or when the harvester is present within a headland the elevator will otherwise be halted for a predetermined amount of time that is sufficient to perform a cleaning cycle. As such, the cleaning device improves the operation of the agricultural harvester by removing debris lodged between the weigh plate and the elevator frame that may impact the accuracy of the data being generated by the sensor assembly.

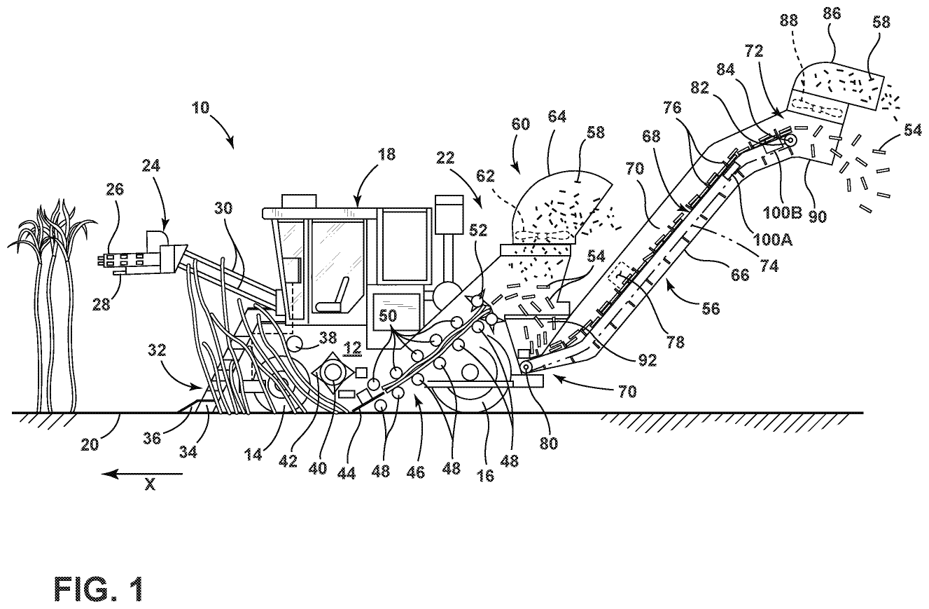

Referring now to the drawings, FIG. 1 illustrates a side view of an agricultural harvester 10 in accordance with aspects of the present subject matter. As shown, the harvester 10 is configured as a sugarcane harvester. However, in other embodiments, the harvester 10 may correspond to any other suitable type of agricultural harvester.

As shown in FIG. 1, the harvester 10 includes a chassis 12, a pair of front wheels 14, a pair of rear wheels 16, and an operator's cab 18. The harvester 10 may also include a source of power (e.g., an engine mounted on the chassis 12) that powers one or both pairs of the wheels 14, 16 via a transmission through an agricultural field 20. Alternatively, the harvester 10 may be a track-driven harvester and, thus, may include tracks driven by the source of power as opposed to the illustrated wheels 14, 16. The source of power may also drive a hydraulic fluid pump configured to generate pressurized hydraulic fluid for powering various hydraulic components of the harvester 10.

The harvester 10 may also include a material processing system 22 incorporating various components, assemblies, and/or sub-assemblies of the harvester 10 for cutting, processing, cleaning, and discharging sugarcane as the cane is harvested from the agricultural field 20. For instance, the material processing system 22 may include a topper assembly 24 positioned at the front end portion of the harvester 10 to intercept sugarcane as the harvester 10 is moved in the forward direction. As shown, the topper assembly 24 may include both a gathering disk 26 and a cutting disk 28. The gathering disk 26 may be configured to gather the sugarcane stalks so that the cutting disk 28 may be used to cut off the top of each stalk. In some cases, the height of the topper assembly 24 may be adjustable via a pair of arms 30 hydraulically raised and lowered, as desired, by the operator.

The material processing system 22 may further include a crop divider 32 that extends upwardly and rearwardly from the field 20. In general, the crop divider 32 may include two spiral feed rollers 34. Each feed roller 34 may include a ground shoe 36 at its lower end portion to assist the crop divider 32 in gathering the sugarcane stalks for harvesting. Moreover, as shown in FIG. 1, the material processing system 22 may include a knock-down roller 38 positioned near the front wheels 14 and a fin roller 40 positioned behind the knock-down roller 38. As the knock-down roller 38 is rotated, the sugarcane stalks being harvested are knocked down while the crop divider 32 gathers the stalks from agricultural field 20. Further, as shown in FIG. 1, the fin roller 40 may include a plurality of intermittently mounted fins 42 that assist in forcing the sugarcane stalks downwardly. As the fin roller 40 is rotated during the harvest, the sugarcane stalks that have been knocked down by the knock-down roller 38 are separated and further knocked down by the fin roller 40 as the harvester 10 continues to be moved in the forward direction relative to the field 20.

Referring still to FIG. 1, the material processing system 22 of the harvester 10 may also include a base cutter assembly 44 positioned behind the fin roller 40. In various examples, the base cutter assembly 44 may include blades for severing the sugarcane stalks as the cane is being harvested. The blades, located on the peripheral portion of the base cutter assembly 44, may be rotated by a hydraulic motor powered by the vehicle's hydraulic system. Additionally, in several embodiments, the blades may be angled downwardly to sever the base of the sugarcane as the cane is knocked down by the fin roller 40.

Moreover, the material processing system 22 may include a feed roller assembly 46 located downstream of the base cutter assembly 44 for moving the severed stalks of sugarcane from base cutter assembly 44 along the processing path of the material processing system 22. As shown in FIG. 1, the feed roller assembly 46 may include a plurality of bottom rollers 48 and a plurality of opposed, top rollers 50. The various bottom and top rollers 48, 50 may be used to pinch the harvested sugarcane during transport. As the sugarcane is transported through the feed roller assembly 46, debris (e.g., rocks, dirt, and/or the like) may be allowed to fall through bottom rollers 48 onto the field 20.

The material processing system 22 may further include a chopper assembly 52 located at the downstream end portion of the feed roller assembly 46 (e.g., adjacent to the rearward-most bottom and top rollers 48, 50). In general, the chopper assembly 52 may be used to cut or chop the severed sugarcane stalks into pieces or “billets” 54, which may be, for example, six (6) inches long. The billets 54 may then be propelled towards an elevator assembly 56 of the material processing system 22 for delivery to an external receiver or storage device.

The pieces of debris 58 (e.g., dust, dirt, leaves, etc.) separated from the sugar billets 54 may be expelled from the harvester 10 through a primary extractor 60 of the material processing system 22, which is located downstream of the chopper assembly 52 and is oriented to direct the debris 58 outwardly from the harvester 10. Additionally, an extractor fan 62 may be mounted within a housing 64 of the primary extractor 60 for generating a suction force or vacuum to force the debris 58 through the primary extractor 60. The separated or cleaned billets 54, heavier than the debris 58 being expelled through the extractor 60, may then be directed to the elevator assembly 56.

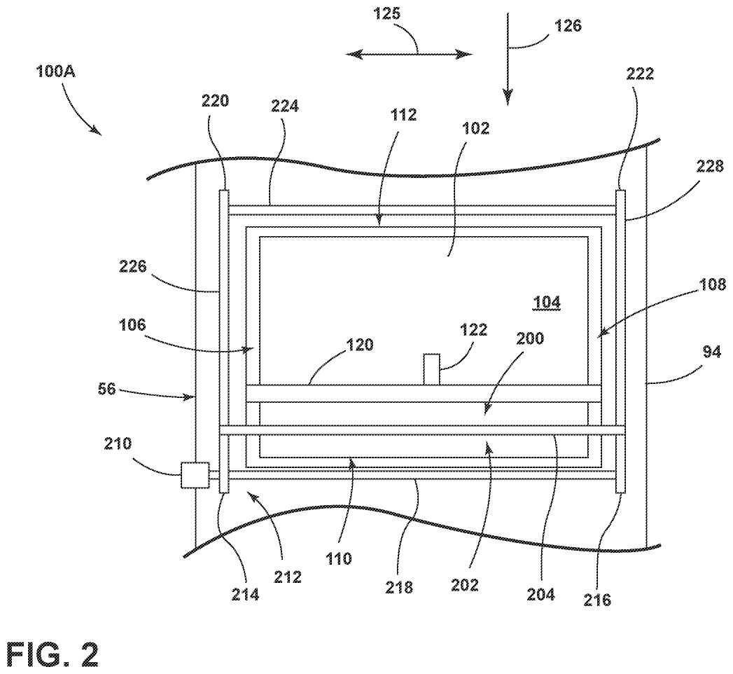

As shown in FIG. 1, the elevator assembly 56 may include an elevator frame 94 (FIG. 2), an elevator housing 66, and an elevator 68 extending within the elevator housing 66 between a lower, proximal end portion 70 and an upper, distal end portion 72. In general, the elevator 68 may include a looped chain 74 and a plurality of flights or paddles 76 attached to and evenly spaced on the chain 74. The paddles 76 may be configured to hold the sugar billets 54 on the elevator 68 as the billets 54 are elevated along a top span of the elevator 68 defined between its proximal and distal end portions 70, 72. A region 78 for retaining the harvested material may be defined between first and second paddles 76 operably coupled with the elevator 68. As such, a first region may be defined between first and second paddles 76, a second region may be defined between the second and a third paddle 76, and so on. Additionally, the elevator 68 may include lower and upper sprockets 80, 82 positioned at its proximal and distal end portions 70, 72, respectively. As shown in FIG. 1, an elevator motor 84 may be coupled to one of the sprockets (e.g., the upper sprocket 82) for driving the chain 74, thereby allowing the chain 74 and the paddles 76 to travel in a loop between the proximal and distal end portions 70, 72 of the elevator 68.

Moreover, in some embodiments, the pieces of debris 58 (e.g., dust, dirt, leaves, etc.) separated from the elevated sugar billets 54 may be expelled from the harvester 10 through a secondary extractor 86 of the material processing system 22 coupled to the rear end portion of the elevator housing 66. For example, the debris 58 expelled by the secondary extractor 86 remaining after the billets 54 are cleaned and debris 58 expelled by the primary extractor 60. As shown in FIG. 1, the secondary extractor 86 may be located adjacent to the distal end portion 72 of the elevator 68 and may be oriented to direct the debris 58 outwardly from the harvester 10. Additionally, an extractor fan 88 may be mounted at the base of the secondary extractor 86 for generating a suction force or vacuum sufficient to force the debris 58 through the secondary extractor 86. The separated, cleaned billets 54, heavier than the debris 58 expelled through the extractor 86, may then fall from the distal end portion 72 of the elevator 68. In some examples, the billets 54 may be directed into an elevator discharge opening 90 of the elevator assembly 56 into an external storage device, such as a sugar billet cart.

During operation, the harvester 10 is traversed across the agricultural field 20 for harvesting sugarcane. After the height of the topper assembly 24 is adjusted via the arms 30, the gathering disk 26 on the topper assembly 24 may function to gather the sugarcane stalks as the harvester 10 proceeds across the field 20, while the cutter disk 28 severs the leafy tops of the sugarcane stalks for disposal along either side of harvester 10. As the stalks enter the crop divider 32, the ground shoes 36 may set the operating width to determine the quantity of sugarcane entering the throat of the harvester 10. The spiral feed rollers 34 then gather the stalks into the throat to allow the knock-down roller 38 to bend the stalks downwardly in conjunction with the action of the fin roller 40. Once the stalks are angled downward as shown in FIG. 1, the base cutter assembly 44 may then sever the base of the stalks from field 20. The severed stalks are then, by the movement of the harvester 10, directed to the feed roller assembly 46.

The severed sugarcane stalks are conveyed rearwardly by the bottom and top rollers 48, 50, which compress the stalks, make them more uniform, and shake loose debris 58 to pass through the bottom rollers 48 to the field 20. At the downstream end portion of the feed roller assembly 46, the chopper assembly 52 cuts or chops the compressed sugarcane stalks into pieces or billets 54 (e.g., six-inch cane sections). The processed crop material discharged from the chopper assembly 52 is then directed as a stream of billets 54 and debris 58 into the primary extractor 60. The airborne debris 58 (e.g., dust, dirt, leaves, etc.) separated from the sugar billets is then extracted through the primary extractor 60 using suction created by the extractor fan 62. The separated/cleaned billets 54 are then directed into an elevator hopper 92 and then into the elevator assembly 56 where the billets 54 travel upward via the elevator 68 from its proximal end portion 70 to its distal end portion 72. During normal operation, once the billets 54 reach the distal end portion 72 of the elevator 68, the billets 54 fall through the elevator discharge opening 90 to an external storage device. If provided, the secondary extractor 86 (with the aid of the extractor fan 88) blows out trash/debris 58 from harvester 10, similar to the primary extractor 60.

Additionally, the harvester 10 may include one or more sensor assemblies 100A, 100B for monitoring the crop yield as the harvester 10 travels across the field to perform a harvesting operation thereon. Specifically, in several embodiments, the harvester 10 may include a first sensor assembly 100A positioned within the elevator assembly 56 at a location between its proximal and distal end portions 70, 72, such as adjacent to the bend in the elevator assembly 56. Moreover, in several embodiments, the harvester 10 may include a second sensor assembly 100B positioned within the elevator assembly 56 at its distal end portion 72. As will be described below, the sensor assemblies 100A, 100B are configured to generate data indicative of the weight of the separated/cleaned billets 54 being conveyed by the elevator assembly 56. However, in alternative embodiments, the harvester 10 may have any other suitable number of sensor assemblies and/or the sensor assembly (ies) may be positioned at any other suitable location(s) n within the elevator assembly 56.

It should be further appreciated that the configuration of the agricultural harvester 10 described above and shown in FIG. 1 is provided only to place the present subject matter in an exemplary field of use. Thus, it should be appreciated that the present subject matter may be readily adaptable to any manner of harvester configuration.

Referring now to FIGS. 2-4, differing views of the first sensor assembly 100A are illustrated in accordance with aspects of the present subject matter. Specifically, FIGS. 2-4 illustrate one embodiment of a cleaning device 200 in operative association with the first sensor assembly 100A. As such, FIG. 2 illustrates a bottom view of the first sensor assembly 100A. Furthermore, FIG. 2 illustrates a top view of the first sensor assembly 100A. Additionally, FIG. 2 illustrates a partial side view of the first sensor assembly 100A.

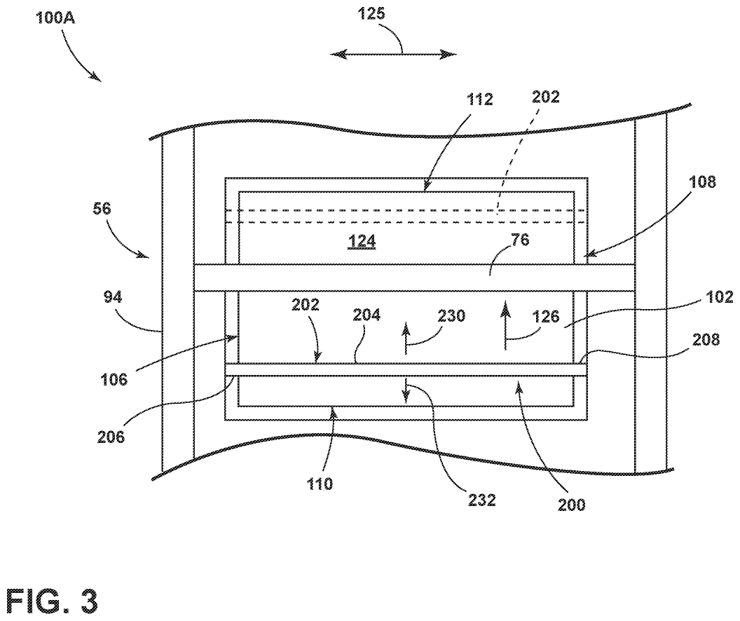

As shown in FIG. 2, the first sensor assembly 100A includes a weigh plate 102 coupled to the elevator frame 94 of the elevator assembly 56. The weigh plate 102, in turn, includes a bottom surface 104 and an opposed upper surface 124 (FIG. 3). During operation of the elevator assembly 56, the harvested crop material (e.g., the sugarcane billets) slide or otherwise move across the upper surface 124 of the weigh plate by the paddles 76 in a direction of flow (indicated by arrow 126). In this respect, the weight of the harvested crop material causes the weigh plate 102 to move upward and downward relative to the elevator frame 56. As will be described below, such movement may be detected and used to determine the weight of the harvested crop material on the weigh plate 102.

Moreover, in several embodiments, a load sensor 122 is coupled between the elevator frame 94 and the weigh plate 102. In general, the load sensor 122 is configured to generate data indicative of the weight of the harvested crop material present on the weigh plate 102 (e.g., on the upper surface 124 of the weigh plate 102). For example, in the illustrated embodiment, one end of the load sensor 122 is coupled to the bottom surface 104 of the weigh plate 102, while the other end of the load sensor 122 is coupled to a support bar 120. The support bar 120 may, in turn, be positioned underneath the weigh plate 102 and coupled to the elevator frame 94. However, in alternative embodiments, the load sensor 122 may be coupled between the elevator frame 94 and the weigh plate 102 in any other suitable manner.

The load sensor 122 may be configured as any suitable sensor or sensing device configured to generate data indicative of the weight of the harvested crop material present on the weigh plate 102. For example, in some embodiments, the load sensor 122 is configured as a load cell. However, in alternative embodiments, the load sensor 122 may be configured as any other suitable sensor or sensing device.

Furthermore, one or more gaps are defined between the weigh plate 102 and the elevator frame 94 to permit pivotable movement therebetween. For example, in the illustrated embodiment, the weigh plate 102 and the elevator frame 94 define first, second, third, and fourth gaps 106, 108, 110, 112 therebetween. In such an embodiment, the first and second gaps 106, 108 may be parallel to each other and the third and fourth gaps 110, 112 may be parallel to each other. As such, the first and second gaps 106, 108 may be perpendicular to the third and fourth gaps 110, 112.

As indicated above, the cleaning device 200 is provided in operative association with the first sensor assembly 100A. More specifically, during operation of the harvester, debris (e.g., dust, dirt, leaves, etc.) may become lodged with the gaps 106, 108, 110, 112. Such debris may interfere with the operation of the first sensor assembly 100A. In this respect, the cleaning device 200 is configured to remove debris from one or more of the gaps 106, 108, 110, 112. For example, as will be described below, in several embodiments, the cleaning device 200 includes a scraper 202 configured to be moved through the one or more of the gaps 106, 108, 110, 112 to remove the debris from such gap(s) 106, 108, 110, 112.

As shown in FIG. 2, in some embodiments, the scraper 202 includes a scraper bar 204 and first and second scraper blades 206, 208 coupled to the scraper 204. Specifically, in such embodiments, the scraper bar 204 may extend across the width of the weigh plate 102 in a lateral direction (indicated by arrow 125), which is perpendicular to the direction of flow 126. Moreover, in such embodiments, the first scraper blade 206 may be coupled to one end of the scraper bar 204 such that at least a portion of the first scraper blade 206 is positioned within the first gap 106. Similarly, the second scraper blade 208 may be coupled to the other end of the scraper bar 204 such that at least a portion of the second scraper blade 208 is positioned within the second gap 108. In this respect, and as will be described below, as the scraper 202 moves relative to the weigh plate 102, the scraper bar 204 sweeps across the upper surface 124 of the weigh plate 102 and the first and second scraper blades 206, 208 respectively move through the first and second gaps 106, 108.

Additionally, the cleaning device 200 may include an actuator 210 and a drive system 212. More specifically, the drive system 212 may be coupled to the actuator 210 and the scraper 202. In this respect, the drive system 212 is configured to transmit motion from the actuator 210 to the scraper 202 such that the scraper 202 is moved relative to the weigh plate 102. As will be described below, such movement of the scraper 202, in turn, removes debris lodges within one or more of the gaps 106, 108, 110, 112.

In several embodiments, the drive system 212 may include one or more rotational elements and one or more continuous bands that transmit motion from the actuator 210 to the scraper 202. More specifically, in the illustrated embodiment, the drive system 212 includes a first rotational element 214 and a second rotational element 216 that is spaced apart from the first rotational element 214 in the lateral direction 125 and aligned with the first rotational element 214 along the direction of flow 126. Furthermore, in the illustrated embodiment, the drive system 212 includes a third rotational element 220 that is spaced apart from the first rotational element 214 along the direction of flow 126 and aligned with the first rotational element 214 in the lateral direction 125. Moreover, in the illustrated embodiment, the drive system 212 includes a fourth rotational element 222 that is spaced apart from the second rotational element 216 along the direction of flow 126 and aligned with the second rotational element 216 in the lateral direction 125. A first axle 218 is coupled to and extends between the first and second rotational elements 214, 216, and a second axle 224 is coupled to and extends between the third and fourth rotational elements 220, 222. Additionally, a first continuous band 226 is operably coupled to the first and third rotational elements 214, 220 and coupled to the scraper 202. Similarly, a second continuous band 228 is operably coupled to the second and fourth rotational elements 216, 222 and coupled to the scraper 202. However, in alternative embodiments, the drive system 212 may have any other suitable configuration that transmits motion from the actuator 210 to the scraper 202.

In some embodiments, the first, second, third, and fourth rotational elements 214, 216, 220, 222 and the first and second continuous bands 226, 228 are positioned underneath a portion of the elevator frame 94. In such embodiments, the first, second, third, and fourth rotational elements 214, 216, 220, 222 and the first and second continuous bands 226, 228 are aligned with the elevator frame 94 in the lateral direction 125 and spaced apart from the weigh plate 102 in the lateral direction 125. Such positioning protects these components from debris and reduces interference with the operation of the sensor assembly 100A. However, in other embodiments, the first, second, third, and fourth rotational elements 214, 216, 220, 222 and the first and second continuous bands 226, 228 may be driven in any other suitable manner.

Additionally, the rotational element(s) and the continuous band(s) may have any suitable configuration that allows for operation as described herein. For example, in one embodiment, the rotational element(s) is configured as a sprocket(s) and the continuous band(s) is configured as a chain(s). In another embodiment, the rotational element(s) is configured as a pulley(s) and the continuous band(s) is configured as a belt(s).

Moreover, the actuator 210 may have any suitable configuration that allows the actuator 210 to drive the scraper 202 via the drive system 212. For example, the actuator 210 may be configured as an electric motor, a hydraulic motor, a pneumatic motor, and/or the like.

As indicated above, the scraper 202 of the cleaning device 200 is configured to remove debris lodged in one or more of the gaps 106, 108, 110, 112. More specifically, as shown in FIG. 2, when the cleaning device 200 is deactivated (e.g., not moving relative to the weigh plate 102), the scraper 202 is positioned at its home position. When at the home position, the scraper bar 204 is positioned underneath the weigh plate 102 as shown in FIG. 2. Upon activation of the cleaning device 200, the actuator 210 rotates or otherwise drives the first rotational element 214, thereby rotating the other rotational elements 216, 220, 222; the axles 218, 224; and the continuous bands 226, 228. Such that rotation of the continuous bands 226, 228 moves the scraper relative to the weigh plate 102.

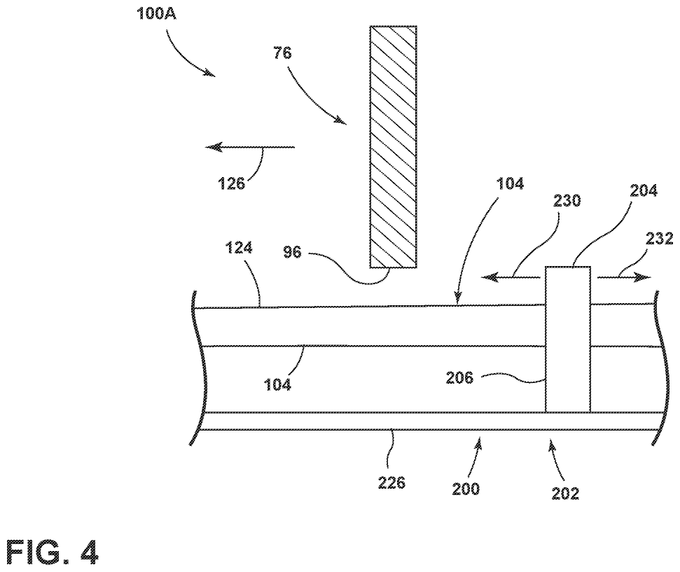

As shown in FIGS. 3 and 4, in some embodiments, the scraper 202 is moveable relative to the weigh plate 102 in a first direction (indicated by arrow 230) that corresponds to the direction of flow 126 of the harvested crop material relative to the weigh plate 102 and in a second direction (indicated by arrow 232) that is opposite of the first direction 230. For example, when the actuator 210 moves the scraper 202 in the first direction 230, the scraper 202 moves from its home position shown in FIG. 2 such that the scraper blades 206, 208 respectively move through the first and second gaps 106, 108 and the scraper bar 204 along the bottom surface 104 of the weigh plate 102. The scraper bar 204 then moves through the third gap 110 and then sweeps across the upper surface 124 of the weigh plate 102 as shown in FIG. 3, with the scraper blades 206, 208 respectively moving back through the first and second gaps 106, 108. Conversely, when the actuator 210 moves the scraper 202 in the second direction 232, the scraper 202 moves from its home position shown in FIG. 2 such that the scraper blades 206, 208 respectively move through the first and second gaps 106, 108 and the scraper bar 204 along the bottom surface 104 of the weigh plate 102. The scraper bar 204 then moves through the fourth gap 112 and then sweeps across the upper surface 124 of the weigh plate 102 (e.g., as indicated by dashed lines in FIG. 3), with the scraper blades 206, 208 respectively moving back through the first and second gaps 106, 108. As shown in FIG. 4, when the scraper bar 204 moves across the upper surface 124 of the weigh plate 102, the scraper bar 204 also sweeps along a bottom surface(s) 96 of any paddles 74 positioned over of the weigh plate 102.

In the embodiment shown in FIGS. 2-4, the actuator 210 is configured to rotationally drive the rotational elements 216, 220, 222; the axles 218, 224; and the continuous bands 226, 228 independently of the elevator 68. That is, the rotation of the rotational elements 216, 220, 222 is not caused by the elevator 68 or any of its components (e.g., the elevator motor 84). However, as will be described below, in other embodiments, the rotational elements 216, 220, 222 may be rotationally driven by the elevator 68 (e.g., the elevator motor 84).

Although the embodiment shown in FIGS. 2-4 includes a single scraper 202, the cleaning device 200, in other embodiments, may include additional scrapers 202. For example, in one embodiment, the cleaning device 200 may include a first scraper configured to move through the third gap 110 and a second scraper configured to move through the fourth gap 112.

Additionally, although the embodiment of the cleaning device 200 shown in FIGS. 2-4 is described in the context of being installed in operative association with the first sensor assembly 100A, this embodiment of the cleaning device 200 could be installed in operative association with the second sensor assembly 100B or any other suitable sensor assembly.

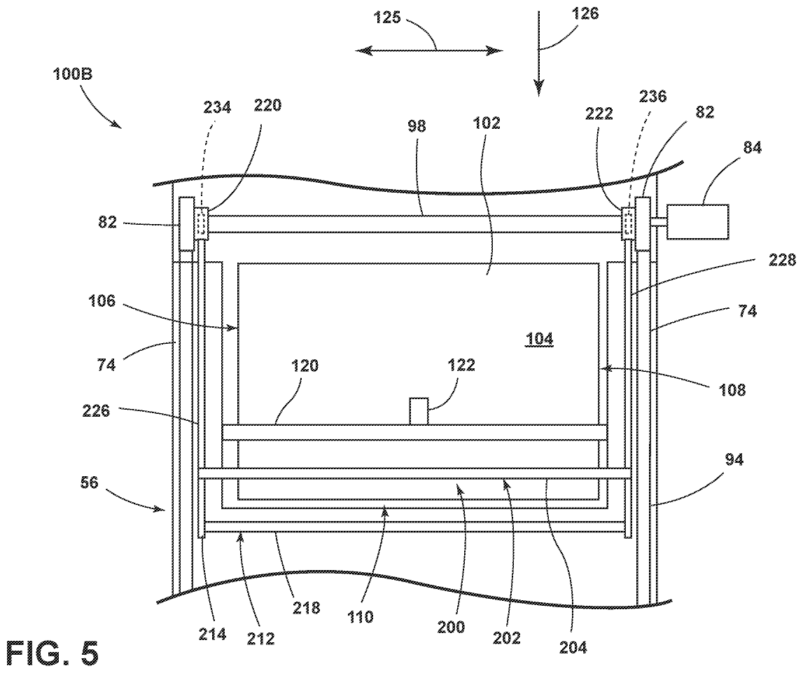

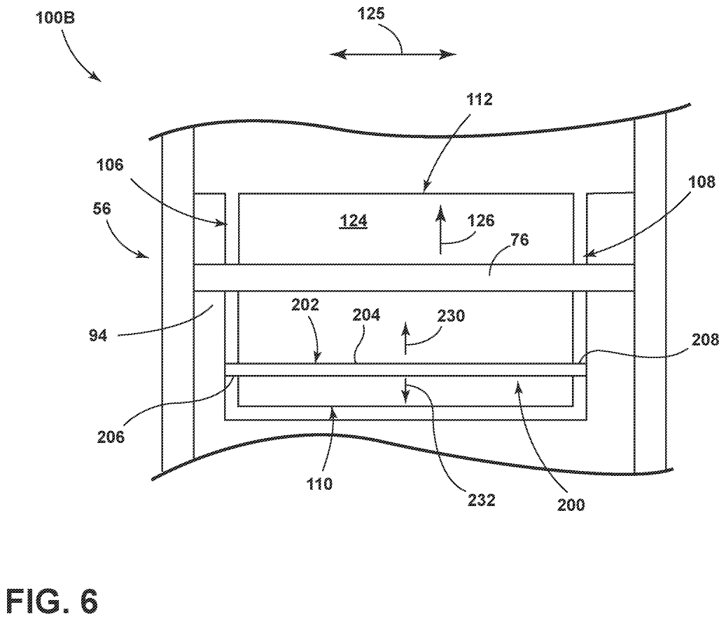

Referring now to FIGS. 5 and 6, differing views of the second sensor assembly 100B are illustrated in accordance with aspects of the present subject matter. Specifically, FIGS. 5 and 6 illustrate another embodiment of a cleaning device 200 in operative association with the second sensor assembly 100B. As such, FIG. 2 illustrates a bottom view of the second sensor assembly 100B. Furthermore, FIG. 2 illustrates a top view of the second sensor assembly 100B.

The second sensor assembly 100B is configured similarly to the first sensor assembly 100A. For example, the second sensor assembly 100B includes the weigh plate 102 coupled to the elevator frame 94 and the load sensor 122 coupled between the elevator frame 94 and the weigh plate 102 such that the load sensor 122 is configured to generate data indicative of the weight of the harvested crop material present on the weigh plate 102. Furthermore, the weigh plate 102 and the elevator frame 94 define the first, second, and third gaps 106, 108, 110 therebetween. However, unlike the first sensor assembly 100A, the second sensor assembly 100B does not include the fourth gap 112 defined between the weigh plate 102 and the elevator frame 94. Rather, the weigh plate 102 of the second sensor assembly 100B is positioned at the distal end portion 72 of the elevator assembly 56. In this respect, an elevator axle 98 coupled between the upper sprockets 82 of the elevator 68 is positioned adjacent to the weigh plate 102.

Additionally, the embodiment of the cleaning device 200 shown in FIGS. 5 and 6 is similar to the embodiment of the cleaning device 200 shown in FIGS. 2-4. For example, like the embodiment of the cleaning device 200 shown in FIGS. 2-4, the embodiment of the cleaning device 200 shown in FIGS. 5 and 6 includes the scraper 202 having the scraper bar 204 and the first and second scraper blades 206, 208. Moreover, like the embodiment of the cleaning device 200 shown in FIGS. 2-4, the embodiment of the cleaning device 200 shown in FIGS. 5 and 6 includes the drive system 212 having the rotational elements 214, 216, 220, 222; the axle 218; and the continuous bands 226, 228.

However, unlike the embodiment of the cleaning device 200 shown in FIGS. 2-4, in the embodiment of the cleaning device 200 shown in FIGS. 5 and 6, the scraper 202 and the drive system 212 are not driven by the actuator 210 independently of the elevator assembly 56. Rather, in the embodiment of the cleaning device 200 shown in FIGS. 5 and 6, the scraper 202 and the drive system 212 are driven by the elevator motor 84. More specifically, in such an embodiment, the third and fourth rotational elements 220, 222 are coupled to the upper sprockets 82 and/or the elevator axle 98 such that the elevator motor 84 moves the scraper 202 relative to the weigh plate 102 via the drive system 212. Thus, the first and second continuous bands 226, 228 may be operably coupled to the upper sprockets 82. Moreover, the second axle 224 is not present in the embodiment shown in FIGS. 5 and 6.

In some embodiments, one or more clutches 234, 236 are coupled between the third and fourth rotational elements 220, 222 and the upper sprockets 82. In general, the clutches 234, 236 are configured to selectively engage and disengage the continuous bands 226, 228 from the sprockets 82. For example, in the illustrated embodiment, a first clutch 234 is coupled between the third rotational element 220 and one of the upper sprockets 82. In this respect, the first clutch 234 is configured to selectively engage and disengage the first continuous band 226 from the corresponding upper sprocket 82. Similarly, in the illustrated embodiment, a second clutch 236 is coupled between the fourth rotational element 222 and the other upper sprocket 82. As such, the second clutch 236 is configured to selectively engage and disengage the second continuous band 228 from the corresponding upper sprocket 82. However, in alternative embodiments, the continuous bands 226, 228 may be selectively engaged with and disengaged from the continuous bands 226, 228 in any other suitable manner.

As indicated above, the scraper 202 of the cleaning device 200 is configured to remove debris lodged in one or more of the gaps 106, 108, 110, 112. More specifically, as shown in FIG. 5, when the cleaning device 200 is deactivated (e.g., not moving relative to the weigh plate 102), the scraper 202 is positioned at its home position. Upon activation of the cleaning device 200, the first and second clutches 234, 236 couple the third and fourth rotational elements 220, 222 to the upper sprockets 82. Thereafter, the elevator motor 84 rotates or otherwise drives the third and fourth rotational elements 220, 222, thereby rotating the other rotational elements 214, 216; the axles 218; and the continuous bands 226, 228. Such that rotation of the continuous bands 226, 228 moves the scraper relative to the weigh plate 102.

As shown in FIG. 6, in some embodiments, the scraper 202 is moveable relative to the weigh plate 102 in the first direction 230 and in the second direction 232. For example, when the actuator 210 moves the scraper 202 in the first direction 230, the scraper 202 moves from its home position shown in FIG. 5 such that the scraper blades 206, 208 respectively move through the first and second gaps 106, 108 and the scraper bar 204 along the bottom surface 104 of the weigh plate 102. The scraper bar 204 then moves through the third gap 110 and then sweeps across the upper surface 124 of the weigh plate 102 as shown in FIG. 6, with the scraper blades 206, 208 respectively moving back through the first and second gaps 106, 108. As mentioned above, when the scraper bar 204 moves across the upper surface 124 of the weigh plate 102, the scraper bar 204 also sweeps along the bottom surface(s) 96 (FIG. 4) of any paddles 74 positioned over of the weigh plate 102. The scraper 202 may subsequently be moved in the second direction 232 to return to its home position.

Although the embodiment of the cleaning device 200 shown in FIGS. 5 and 6 is described in the context of being installed in operative association with the second sensor assembly 100B, this embodiment of the cleaning device 200 could be installed in operative association with the first sensor assembly 100A or any other suitable sensor assembly.

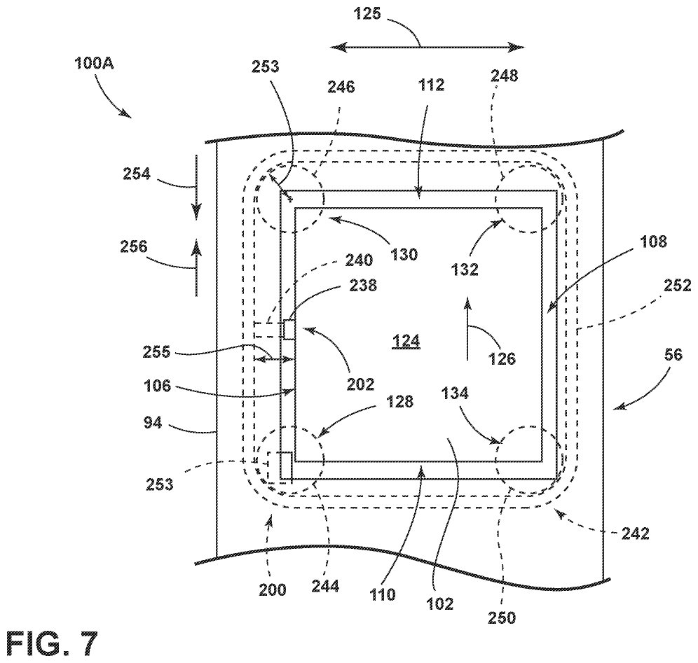

Referring now to FIG. 7, a top view of the first sensor assembly 100A is illustrated in accordance with aspects of the present subject matter. Specifically, FIG. 7 illustrates a further embodiment of a cleaning device 200 in operative association with the first sensor assembly 100A.

As shown, the cleaning device 200 includes a scraper 202 having a scraper blade 238 positioned within the first gap 106. As will be described below, the scraper blade 238 may be moved through the first gap 106 to remove debris lodged within the first gap 106. Although not shown, additional scraper blades may be positioned within the second, third, and/or fourth gaps 108, 110, 112.

Furthermore, the cleaning device 200 includes a drive system 242 configured to move the scraper blade 238 relative to the weigh plate 102. Specifically, in several embodiments, the drive system 242 includes first, second, third, and fourth rotational elements 244, 246, 248, 250 respectively positioned adjacent to first, second, third, and fourth corners 128, 130, 132, 134 of the weigh plate 102. Moreover, the first, second, third, and fourth rotational elements 244, 246, 248, 250 are positioned underneath the weigh plate 102 and the elevator frame 94, with their axes of rotation oriented orthogonal to the upper surface 124 of the weigh plate 102. Additionally, the drive system 242 includes a continuous band 252 operably coupled to the first, second, third, and fourth rotational elements 244, 246, 248, 250. The continuous band 252 is, in turn, coupled to the scraper 202 via a scraper arm 240. As such, rotation of at least one of the first, second, third, and fourth rotational elements 244, 246, 248, 250 causes the continuous band 252 and, thus, the scraper 202 to move relative to the weigh plate 102. For example, in the illustrated embodiment, an actuator 253 may be configured to rotationally drive the first rotational element 244. However, in alternative embodiments, any of the rotational elements 244, 246, 248, 250 may be driven.

As shown, in several embodiments, the scraper blade 238 is spaced apart from the continuous band 252 by the scraper arm 240. Specifically, in some embodiments, the scraper blade 238 is spaced apart from the continuous band 252 by an offset (indicated by arrow 255) that is equal to a radius (indicated by arrow 253) of the first, second, third, and fourth rotational elements 244, 246, 248, 250. Such an offset allows the scraper blade 238 to navigate the right angles defined by the adjacent gaps 106, 108, 110, 112.

Additionally, the rotational element(s) and the continuous band(s) may have any suitable configuration that allows for operation as described herein. For example, in one embodiment, the rotational element(s) is configured as a sprocket(s) and the continuous band(s) is configured as a chain(s). In another embodiment, the rotational element(s) is configured as a pulley(s) and the continuous band(s) is configured as a belt(s).

Moreover, the actuator 253 may have suitable configuration that allows the actuator 253 to drive the scraper 202 via the drive system 242. For example, the actuator 253 may be configured as an electric motor, a hydraulic motor, a pneumatic motor, and/or the like.

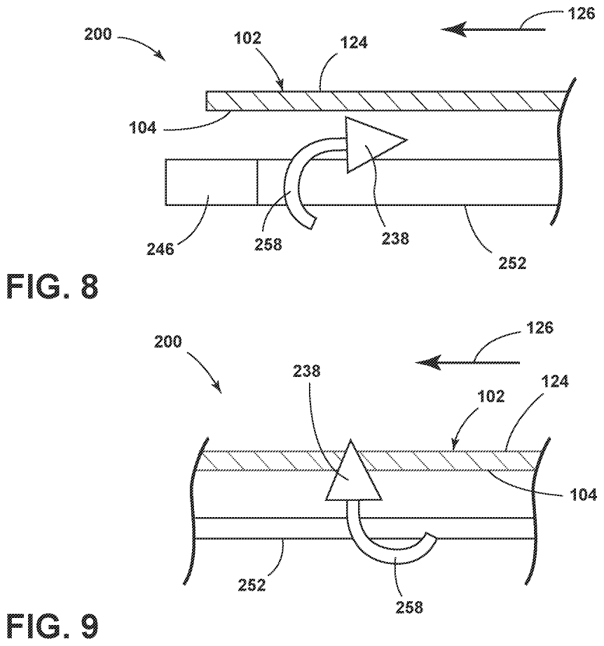

Referring now to FIGS. 8 and 9, partial side views of the cleaning device 200 shown in FIG. 7 are illustrated in accordance with aspects of the present subject matter. Specifically, as shown, the scraper 202 includes an activation arm 258 coupled to the scraper blade 238. The activation arm 258, in turn, extends outward from the bottom of the scraper blade 238 (e.g., in an arcuate manner). In this respect, and as will be described below, when the activation arm 258 contacts one of the rotational elements (e.g., the second rotational element 246), the scraper blade 238 pivots from its home position shown in FIG. 8 to its activated position shown in FIG. 9. When at the home position, the scraper blade 238 is positioned below the upper surface 124 of the weigh plate 102 such that the harvested crop present on the weigh plate does not damage the scraper blade 238. Conversely, when at the activated position, the scraper blade 238 extends upward through the corresponding gap (e.g., the first gap 106) such that its upper tip or end is positioned above the upper surface 124 of the weigh plate 102. Thus, the scraper blade 238 can dislodge debris from the corresponding gap when moved through the gap at activated position.

Referring now to FIGS. 7-9, as indicated above, the scraper 202 of the cleaning device 200 is configured to remove debris lodged in one or more of the gaps 106, 108, 110, 112. More specifically, as shown in FIGS. 7 and 8, when the cleaning device 200 is deactivated (e.g., not moving relative to the weigh plate 102), the scraper 202 is positioned at its home position. Upon activation of the cleaning device 200, the actuator 253 rotates the first rotational element 228 such that the continuous band 252 is moved in an activation direction (indicated by arrow 254). As the continuous band 252 moves in the activation direction 254, the activation arm 258 eventually contacts the second rotational element 246, thereby pivoting the scraper blade 238 to its activated position as shown in FIG. 9. Thereafter, the actuator 253 rotates the first rotational element 228 such that the continuous band 252 is moved in a cleaning direction (indicated by arrow 256), which is opposite of the activation direction 254. Movement of the continuous band 252 in the cleaning direction 256 moves the scraper blade 238 through the first gap 106, thereby dislodging any debris present therein. The scraper blade 238 may subsequently be moved from the activated position of FIG. 9 to the home position of FIG. 8 by contact with one of the paddles 76 of the elevator assembly 56. Thereafter, the scraper blade 238 may be reactivated when the elevator chain 74 is stopped and the direction of the continuous band 252 is reversed. This, in turn, causes the activation arm 258 to contact the elevator frame 94 or the continuous band 252, thereby rotating the scraper blade 238 back to active position such that the scraper blade 238 can be moved in the cleaning direction 256 for cleaning the first gap 106.

Although the embodiment of the cleaning device 200 shown in FIGS. 7-9 is described in the context of being installed in operative association with the first sensor assembly 100A, this embodiment of the cleaning device 200 could be installed in operative association with the second sensor assembly 100B or any other suitable sensor assembly.

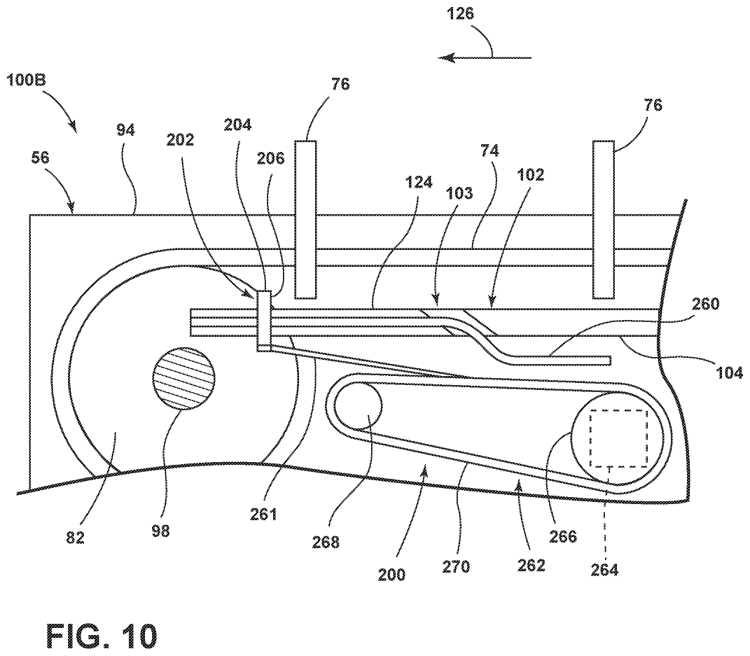

Referring now to FIG. 10, a side view of the second sensor assembly 100B is illustrated in accordance with aspects of the present subject matter. Specifically, FIG. 10 illustrates yet another embodiment of a cleaning device 200 in operative association with the second sensor assembly 100B.

As shown, the cleaning device 200 includes the scraper 202, which is configured similarly to the scrapers 202 in the embodiments of shown in FIGS. 2-6. Specifically, in the illustrated embodiment, the scraper 202 includes the scraper bar 204 and the first scraper blade 206 coupled to the scraper bar 204 and positioned within the first gap 106. Although not shown in FIG. 10, the scraper 202 further includes the second scraper blade 208 coupled to the scraper bar 204 and positioned within the second gap 106. As will be described below, the first and second scraper blades 206, 208 may be moved through the first and second gaps 106, 108 to remove debris lodged within the first and second gaps 106, 108.

Additionally, the cleaning device 200 includes a guiderail 260 positioned underneath the elevator frame 94 and the weigh plate 102. Specifically, in some embodiments, the guiderail 260 may be aligned with the elevator 94 in the lateral direction 125 and spaced apart from the weigh plate 102 in the lateral direction. This, in turn, prevents debris or other material that has accumulated on the guiderail 160 from interfering with the weigh plate 102. In this respect, at least a portion of the scraper 202 may be driven along the guiderail 260 to clean one or more of the gaps 106, 108, 110, 112. As shown, in several embodiments, the guiderail 260 may have a curved portion. For example, in the illustrated embodiment, the guiderail 260 includes a first generally straight portion positioned beneath the weigh plate 102, a second generally straight portion positioned above the first generally straight portion, and a third curved portion coupling the first and second generally straight portions. This, in turn, allows the scraper blades 206, 208 to move upward though gaps 103 (one is shown) and into the first and second gaps 106, 108 by moving upward in an almost straight manner.

Moreover, the cleaning device 200 includes an actuator 264 and a drive system 262 configured to drive at least a portion of the scraper 202 along the guiderail 260. Specifically, in several embodiments, the drive system 262 includes a first rotational element 266 coupled to the actuator 264 and a second rotational element 268 spaced apart from the first rotational element 266. In addition, a continuous band 270 is operably coupled to the first and second rotational elements 264, 268. Moreover, an arm 261 couples the continuous band 270 to the scraper 202. As such, rotation of the first and second rotational elements 264, 268 and the continuous band 270 may drive at least a portion of the scraper 202 along the guiderail 260, thereby cleaning one or more of the gaps 106, 108, 110, 112.

Additionally, the rotational element(s) and the continuous band(s) may have any suitable configuration that allows for operation as described herein. For example, in one embodiment, the rotational element(s) is configured as a sprocket(s) and the continuous band(s) is configured as a chain(s). In another embodiment, the rotational element(s) is configured as a pulley(s) and the continuous band(s) is configured as a belt(s).

Moreover, the actuator 264 may have suitable configuration that allows the actuator 264 to drive the scraper 202 via the drive system 262. For example, the actuator 264 may be configured as an electric motor, a hydraulic motor, a pneumatic motor, and/or the like.

As indicated above, the scraper 202 of the cleaning device 200 is configured to remove debris lodged in one or more of the gaps 106, 108, 110, 112. More specifically, when the cleaning device 200 is deactivated (e.g., not moving relative to the weigh plate 102), the scraper 202 is positioned at its home position below the weigh plate 102. Upon activation of the cleaning device 200, the actuator 264 rotates or otherwise drives the first rotational element 264, thereby rotating the second rotational element 268 and the continuous band 270. Such that rotation of the continuous band 270 drives the scraper 202 along the guiderail 260 and relative to the weigh plate 102 such that the scraper blades 206, 208 is moved up into and through the first and second gaps 106, 108, thereby cleaning such gaps 106, 108. Additionally, in some embodiments, as the scraper 202 moves relative to the weigh plate 102, the scraper bar 204 sweeps across the upper surface 124 of the weigh plate 102.

In the embodiment shown in FIG. 10, the actuator 264 is configured to rotationally drive the rotational elements 264, 268 and the continuous band 270 independently of the elevator 68. As such, the actuator 264 may be configured as an electric motor, a hydraulic motor, a pneumatic motor, and/or the like

Although the embodiment of the cleaning device 200 shown in FIG. 10 is described in the context of being installed in operative association with the second sensor assembly 100B, this embodiment of the cleaning device 200 could be installed in operative association with the first sensor assembly 100A or any other suitable sensor assembly.

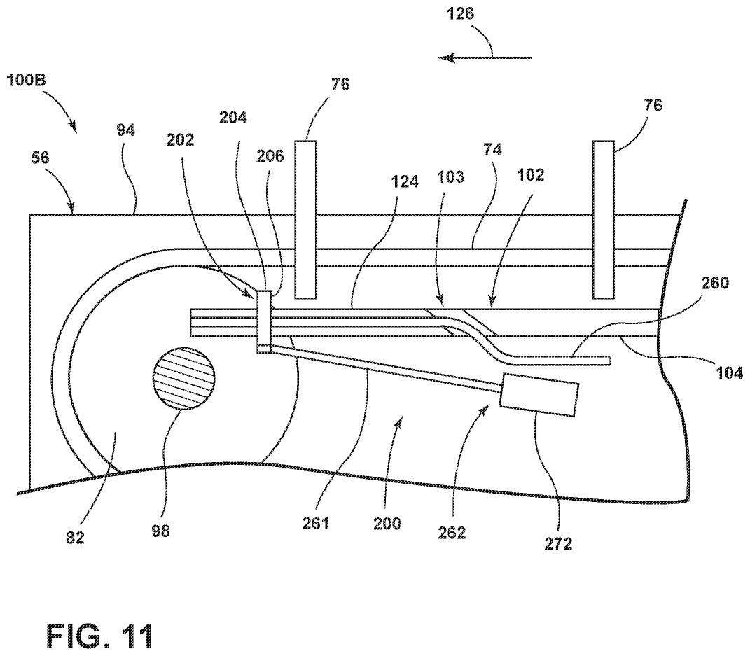

Referring now to FIG. 11, a side view of the second sensor assembly 100B is illustrated in accordance with aspects of the present subject matter. Specifically, FIG. 11 illustrates yet a further embodiment of a cleaning device 200 in operative association with the second sensor assembly 100B.

The embodiment of the cleaning device 200 shown in FIG. 11 is similar to the embodiment of the cleaning device 200 shown in FIG. 10. For example, like the embodiment of the cleaning device 200 shown in FIG. 10, the embodiment of the cleaning device 200 shown in FIG. 11 includes the scraper 202 and the guiderail 260 through which at least a portion of the scraper 202 is driven. However, unlike the embodiment of the cleaning device 200 shown in FIG. 10, the embodiment of the cleaning device 200 shown in FIG. 11 includes an actuator 272 configured to configured to drive at least a portion of the scraper 202 through the guiderail 260. In the embodiment shown in FIG. 11, the actuator 272 is configured as a linear actuator, such a linear electric actuator, a hydraulic cylinder, a pneumatic cylinder, etc.

Although the embodiment of the cleaning device 200 shown in FIG. 11 is described in the context of being installed in operative association with the second sensor assembly 100B, this embodiment of the cleaning device 200 could be installed in operative association with the first sensor assembly 100A or any other suitable sensor assembly.

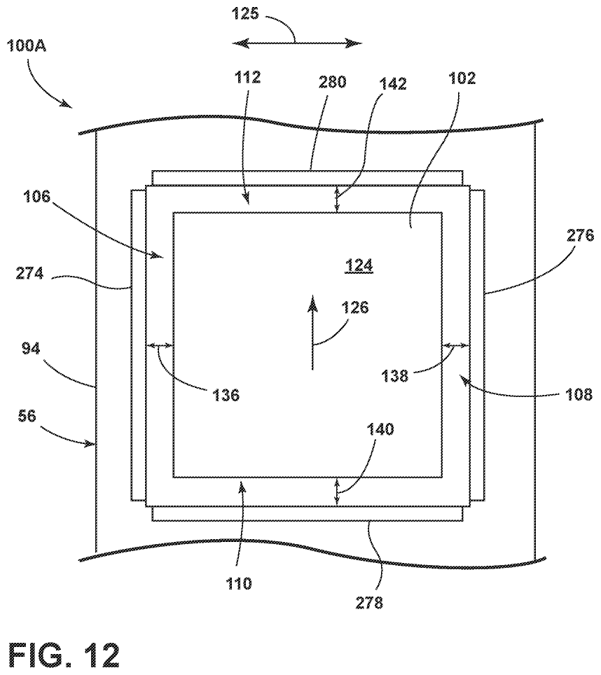

Referring now to FIG. 12, a top view of the first sensor assembly 100A is illustrated in accordance with aspects of the present subject matter. Specifically, FIG. 12 illustrates a further embodiment of a cleaning device 200 in operative association with the first sensor assembly 100A.

As shown, the cleaning device 200 includes one or more shape memory alloy components 274, 276, 278, 280 at least partially defining one or more of the gaps 106, 108, 110, 112. In general, the shape memory alloy component(s) 274, 276, 278, 280 may selectively adjust (e.g., increase or decrease) the width(s) of the gap(s) 106, 108, 110, 112 in a manner that dislodges debris present therein. For example, in the illustrated embodiment, the cleaning device 200 includes a first shape memory alloy component 274 at least partially defining the first gap 106 such that the first shape memory alloy component 274 is configured to selectively adjust a width 136 of the first gap 106. Similarly, in the illustrated embodiment, the cleaning device 200 includes a second shape memory alloy component 276 at least partially defining the second gap 108 such that the second shape memory alloy component 276 is configured to selectively adjust a width 138 of the second gap 108. Furthermore, in the illustrated embodiment, the cleaning device 200 includes a third shape memory alloy component 278 at least partially defining the third gap 110 such that the third shape memory alloy component 278 is configured to selectively adjust a width 140 of the third gap 110. Moreover, in the illustrated embodiment, the cleaning device 200 includes a fourth shape memory alloy component 280 at least partially defining the fourth gap 112 such that the fourth shape memory alloy component 280 is configured to selectively adjust a width 142 of the fourth gap 112. However, in alternative embodiments, only some of the gaps 106, 108, 110, 112 may be partially defined by shape memory alloy components.

As used herein, a shape memory alloy component is a component formed of a material that can be deformed when cold but returns to its pre-deformed or remembered shape when heated. Two non-limiting examples of shape memory alloy are copper-aluminum-nickel and nickel-titanium (NiTi). In this respect, the shape memory alloy component(s) 274, 276, 278, 280 may allow the corresponding gap(s) to have a first width(s) when cold and a second, different width(s) when heated.

Although the embodiment of the cleaning device 200 shown in FIG. 12 is described in the context of being installed in operative association with the first sensor assembly 100A, this embodiment of the cleaning device 200 could be installed in operative association with the second sensor assembly 100B or any other suitable sensor assembly.

Several embodiments of the cleaning device 200 were described in detail above. It will be appreciated that any of these above-described embodiments of the cleaning device 200 can be combined together and or used in conjunction with each other.

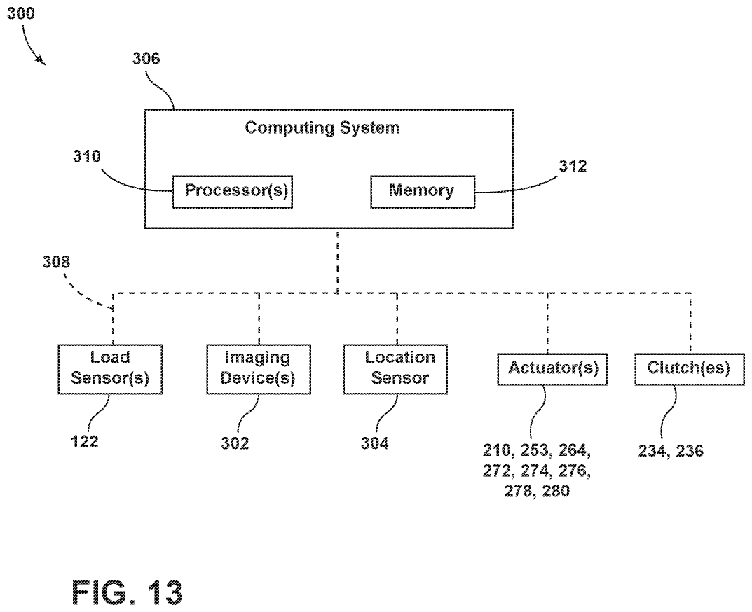

Referring now to FIG. 13, a schematic view of one embodiment of a system 300 for cleaning sensor assemblies of an agricultural harvester is illustrated in accordance with aspects of the present subject matter. In general, the system 300 will be described herein with reference to the agricultural harvester 10 described above with reference to FIGS. 1-12. However, it should be appreciated by those of ordinary skill in the art that the disclosed system 300 may generally be utilized with agricultural harvesters having any other suitable harvester configuration.

As shown in FIG. 13, the system 300 includes one or more components of the agricultural harvester 10. For example, the system 300 may include the load sensor(s) 122; one or more of the various actuators 210, 253, 264, 272, 274, 276, 278, 280; and/or the clutches 234, 236.

Furthermore, the system 300 may include one or more one or more imaging devices 302 mounted on or otherwise supported on the agricultural harvester 10. In general, the imaging devices(s) 302 may be configured to capture images depicting one or more of the gaps 106, 108, 110, 112 around the weigh plate 102 of the sensor assemblies 100A, 100B. As will be described below, a computing system may be configured to analyze the captured images to determine when debris is present within the gap(s) 106, 108, 110, 112. Thereafter, the cleaning device(s) 200 may be activated to remove the debris present within the gap(s) 106, 108, 110, 112.

In general, the imaging device(s) 302 may correspond to any suitable device(s) configured to capture images or other image data depicting one or more of the gaps 106, 108, 110, 112 around the weigh plate 102. For example, in one embodiment, the imaging device(s) 302 may correspond to a camera(s) configured to capture images of the gap(s) 106, 108, 110, 112 present within its field of view. However, in alternative embodiments, the imaging device(s) 302 may correspond to any other suitable sensing device(s) configured to capture images or image-like data, such as a LIDAR sensor(s) or a RADAR sensor(s).

Additionally, the system 300 may include a location sensor 304 provided in operative association with the agricultural harvester 10. In general, the location sensor 304 may be configured to determine the current location of the harvester 10 using a satellite navigation positioning system (e.g., a GPS system, a Galileo positioning system, the Global Navigation satellite system (GLONASS), the BeiDou Satellite Navigation and Positioning system, and/or the like). In such an embodiment, the location determined by the location sensor 304 may be transmitted to a computing system of the harvester 10 (e.g., in the form coordinates) and stored within the computing system's memory for subsequent processing and/or analysis.

Moreover, the system 300 includes a computing system 306 communicatively coupled to one or more components of the agricultural harvester 10 and/or the system 300 to allow the operation of such components to be electronically or automatically controlled by the computing system 306. For instance, the computing system 306 may be communicatively coupled to the sensors 122, 302, 304 via a communicative link 308. As such, the computing system 306 may be configured to receive data from the sensors 122, 302, 304 that is indicative of a need to clean the gap(s) 106, 108, 110, 112. Furthermore, the computing system 306 may be communicatively coupled to the actuators 210, 253, 264, 272, 274, 276, 278, 280 and/or the clutches 234, 236 via the communicative link 308. In this respect, the computing system 306 may be configured to control the operation of the actuators 210, 253, 264, 272, 274, 276, 278, 280 and/or the clutches 234, 236 to activate the corresponding cleaning device(s) 200. In addition, the computing system 306 may be communicatively coupled to any other suitable components of the agricultural harvester 10 and/or the system 300.

In general, the computing system 306 may comprise one or more processor-based devices, such as a given controller or computing device or any suitable combination of controllers or computing devices. Thus, in several embodiments, the computing system 306 may include one or more processor(s) 310 and associated memory device(s) 312 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 310 of the computing system 306 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 310 may generally be configured to store suitable computer-readable instructions that, when implemented by the processor(s) 310, configure the computing system 306 to perform various computer-implemented functions, such as one or more aspects of the methods and algorithms that will be described herein. In addition, the computing system 306 may also include various other suitable components, such as a communications circuit or module, one or more input/output channels, a data/control bus and/or the like.

The various functions of the computing system 306 may be performed by a single processor-based device or may be distributed across any number of processor-based devices, in which instance such devices may be considered to form part of the computing system 306. For instance, the functions of the computing system 306 may be distributed across multiple application-specific controllers or computing devices, such as a navigation controller, an engine controller, a transmission controller, and/or the like.

In several embodiments, the computing system 306 may be configured to initiate activation of the cleaning device 200 to clean the sensor assembly (ies) 100A, 100B based on at least one of image data depicting the gap(s) 106, 108, 110, 112; the data generated by the load sensor(s) 122; or an input indicating that the agricultural harvester 10 is present in a headland or that the elevator 68 will be halted for a predetermined amount of time for the cleaning device 200 to complete a cleaning cycle. Specifically, in such embodiments, the computing system 306 may receive such data via the communicative link 308, analyze the received data, and determine when debris has accumulated or has likely accumulated within the gap(s) 106, 108, 110, 112. For example, in some embodiments, the computing system 306 may analyze image data captured by the imaging device(s) 302 to determine when debris has accumulated within the gap(s) 106, 108, 110, 112. Additionally, or alternatively, the computing system 306 may analyze data generated by the load sensor(s) 122 to determine when operation of the sensor assembly (ies) 100A, 100B is abnormal, such as due to debris present within the gap(s) 106, 108, 110, 112. Additionally, or alternatively, the computing system 306 may determine when the elevator 68 of the agricultural harvester 10 is halted for a predetermined amount of time sufficient for the cleaning device 200 to complete a cleaning cycle (e.g., of one or more of the gap(s) 106, 108, 110, 112). This may, in turn, occur when the harvester 10 is present within a headland as determined based on location data generated by the location sensor 304, the trailer/cart (not shown) into which the harvested crop is being unloaded is sufficiently far away from the elevator discharge opening 90, or the harvesting logistics software indicates that there is sufficient time for the cleaning device 200 to complete a cleaning cycle before the elevator 68 begins to move again as the elevator 74 cannot be started before the scraper 202 is back in its home position. Thereafter, when it determined that debris is present or likely present within one or more of the gap(s) 106, 108, 110, 112 (e.g., based on the image data, load sensor data, or vehicle location) or the elevator 68 has stopped, the computing system 306 may initiate activation of the cleaning device(s) 200, such as by transmitting suitable control signals to the appropriate actuators 210, 253, 264, 272, 274, 276, 278, 280 and/or the clutches 234, 236.

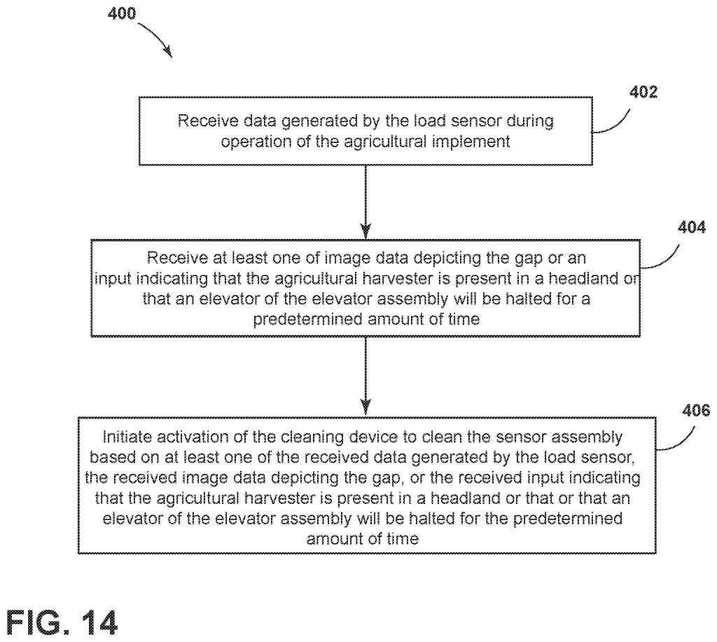

Referring now to FIG. 14, a flow diagram of one embodiment of a method 400 for cleaning sensor assemblies of an agricultural harvester is illustrated in accordance with aspects of the present subject matter. In general, the method 400 will be described herein with reference to the agricultural harvester 10 and the system 300 described above with reference to FIGS. 1-13. However, it should be appreciated by those of ordinary skill in the art that the disclosed method 400 may generally be implemented with any agricultural harvesters having any suitable harvester configuration and/or within any system having any suitable system configuration. In addition, although FIG. 14 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 14, at (402), the method 400 includes receiving, with a computing system, data generated by the load sensor during operation of the agricultural implement. For instance, as described above, the computing system 306 may be configured to receive data generated by the load sensor(s) 122 of the first and/or second sensor assemblies 100A, 100B during operation of the agricultural harvester 10.

Furthermore, at (404), the method 400 includes receiving, with the computing system, at least one of image data depicting the gap or an input indicating that the agricultural harvester is present in a headland. For instance, as described above, the computing system 306 may be configured to receive image data depicting one or more of the gap(s) 106, 108, 110, 112 (e.g., from the imaging device(s) 302) and/or an input indicating that the agricultural harvester 10 is present in a headland (e.g., from the location sensor 304).

Additionally, at (406), the method 400 includes initiating, with the computing system, activation of the cleaning device to clean the sensor assembly based on at least one of the received data generated by the load sensor, the received image data depicting the gap, or the received input indicating that the agricultural harvester is present in a headland or that the elevator will be halted for a predetermined amount of time. For instance, as described above, the computing system 306 may be configured to initiate activation of the cleaning device(s) 200 to clean the first and/or second sensor assemblies 100A, 100B based on the received data generated by the load sensor(s) 122; the received image data depicting the gap(s) 106, 108, 110, 112; or the received input indicating that the agricultural harvester 10 is present in a headland or that the elevator 68 will be halted for a predetermined amount of time, such as a sufficient amount of time for the cleaning device 200 to complete a cleaning cycle.

It is to be understood that the steps of the method 400 are performed by the computing system 306 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 306 described herein, such as the method 400, is implemented in software code or instructions which are tangibly stored on a tangible computer readable medium. The computing system 306 loads the software code or instructions via a direct interface with the computer readable medium or via a wired and/or wireless network. Upon loading and executing such software code or instructions by the computing system 306, the computing system 306 may perform any of the functionality of the computing system 306 described herein, including any steps of and the method 400 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for cleaning sensor assemblies of an agricultural harvester, the system comprising:
an elevator assembly configured to convey harvested crop material, the elevator assembly including an elevator frame;
a sensor assembly positioned within the elevator assembly, the sensor assembly including a weigh plate coupled to the elevator frame such that the weigh plate and the elevator frame define a gap therebetween, the sensor assembly further including a load sensor coupled between the elevator frame and the weigh plate such that the load sensor is configured to generate data indicative of a weight of the harvested crop material present on the weigh plate; and
a cleaning device configured to remove debris from the gap.

2. The system of claim 1, wherein the cleaning device comprises a scraper configured to be moved through the gap to remove the debris from the gap.

3. The system of claim 2, wherein:
the gap corresponds to a first gap positioned between the frame and the weigh plate, the frame and the weigh plate further defining a second gap therebetween, the second gap being parallel to the first gap; and
the scraper comprises a scraper bar and first and second scraper blades coupled to the scraper bar such that, as the scraper moves relative to the weigh plate, the scraper bar sweeps across an upper surface of the weigh plate and the first and second scraper blades respectively move through the first and second gaps.

4. The system of claim 3, wherein the frame and the weigh plate further define third gap therebetween, the third gap being perpendicular to the first and second gaps such that, as the scraper moves relative to the weigh plate, the scraper bar moves into and out of the third gap.

5. The system of claim 3, wherein the scraper is moveable relative to the weigh plate in a first direction that corresponds to a direction of flow of the harvested crop material relative to the weigh plate and in a second direction that is opposite of the first direction.

6. The system of claim 3, wherein the cleaning device comprises a rotational element and a continuous band operably coupled to the rotational element, the continuous band being coupled to the scraper such that rotation of the continuous band moves the scraper relative to the weigh plate.

7. The system of claim 6, wherein the rotational element and the continuous band positioned underneath a portion of the elevator frame and spaced apart from the weigh plate in a lateral direction that is perpendicular to a direction of flow of the harvested crop material relative to the weigh plate.

8. The system of claim 6, wherein the cleaning device further comprises an actuator coupled to and configured to rotationally drive the rotational element independently of an elevator of the agricultural harvester.

9. The system of claim 6, wherein:
the elevator assembly comprises an elevator motor, a sprocket coupled to the motor, a chain configured to be rotationally driven by the sprocket, and a plurality of paddles coupled to the chain; and
the continuous band is operably coupled to the sprocket such that the continuous belt is rotationally driven by the elevator motor.

10. The system of claim 9, wherein the cleaning device further comprises a clutch assembly coupled between the sprocket and the continuous band such that the clutch assembly is configured to selectively engage and disengage the continuous band from the sprocket.

11. The system of claim 1, wherein the cleaning device comprises:
first, second, third, and fourth rotational elements respectively positioned adjacent to first, second, third, and fourth corners of the weigh plate;
a continuous band operably coupled to the first, second, third, and fourth rotational elements such that rotation of at least one of the first, second, third, and fourth rotational elements causes the continuous band to move relative to the weigh plate; and
a scraper including a scraper blade coupled to the continuous band such that the scraper blade is configured to be moved through the gap as the continuous band moves relative to the weigh plate.

12. The system of claim 11, wherein the scraper comprises an activation arm coupled to the scraper blade such that, when the continuous band moves relative to the weigh plate and the scraper arm contacts one of the first, second, third, and fourth rotational elements, the scraper blade is pivoted from a home position to an activated position.

13. The system of claim 12, wherein the scraper blade is pivoted from the activated position to the home position by contact with a paddle of the elevator assembly.

14. The system of claim 11, wherein the scraper is spaced apart from the continuous band by an offset that is equal to a radius of the first, second, third, and fourth rotational elements.

15. The system of claim 1, wherein the cleaning device comprises:
a scraper including a scraper blade configured to be moved through the gap to remove the debris from the gap;
a guiderail positioned underneath the elevator frame; and
an actuator configured to drive at least a portion of the scraper along the guiderail.

16. The system of claim 15, wherein the scraper comprises a scraper bar coupled to the scraper blade such that, as the scraper moves relative to the weigh plate, the scraper bar sweeps across a surface of the weigh plate.

17. The system of claim 1, wherein the cleaning device comprises a shape memory alloy component defining the gap such that shape memory component is configured to selectively adjust a width of the gap.

18. The system of claim 1, further comprising:
a computing system configured to initiate activation of the cleaning device to clean the sensor assembly based on at least one of image data depicting the gap, the data generated by the load sensor, or an input indicating that the agricultural harvester is present in a headland or that an elevator of the elevator assembly will be halted for a predetermined amount of time.

19. An agricultural harvester, comprising:
a chassis;
an elevator assembly supported on the chassis, the elevator assembly configured to convey harvested crop material, the elevator assembly including an elevator frame;
a sensor assembly positioned within the elevator assembly, the sensor assembly including a weigh plate coupled to the elevator frame such that the weigh plate and the elevator frame define a gap therebetween, the sensor assembly further including a load sensor coupled between the elevator frame and the weigh plate such that the load sensor is configured to generate data indicative of a weight of the harvested crop material present on the weigh plate; and
a cleaning device configured to remove debris from the gap.

20. A method for cleaning a sensor assembly of an agricultural harvester, the sensor assembly including a weigh plate coupled to an elevator frame such that a gap is defined between the weigh plate and the elevator frame, the sensor assembly further including a load sensor coupled between the elevator frame and the weigh plate such that the load sensor is configured to generate data indicative of a weight of harvested crop material present on the weigh plate, the method comprising:
receiving, with a computing system, data generated by the load sensor during operation of the agricultural implement;
receiving, with the computing system, at least one of image data depicting the gap or an input indicating that the agricultural harvester is present in a headland or that an elevator of the elevator assembly will be halted for a predetermined amount of time; and
initiating, with the computing system, activation of the cleaning device to clean the sensor assembly based on at least one of the received data generated by the load sensor, the received image data depicting the gap, or the received input indicating that the agricultural harvester is present in a headland or that the elevator will be halted for the predetermined amount of time.
